(19) United States
(12) Patent Application Publication
(10) Pub. No.: US 2006/0005165 A1
(43) Pub. Date: Jan. 5, 2006

(54) System and method for managing the presentation and customization of web applications and web pages

(76) Inventor: Kehinde Alabi, Port Jefferson Stn., NY (US)

Correspondence Address: KEHINDE ALABI, P. O. BOX 358, EAST SETAUKET, NY, 11733, US

(21) Appl. No.: 10/882,811

(22) Filed: Jul. 2, 2004

(51) Int. Cl. G06F 9/44

(52) U.S. Cl. 717/113

(57) ABSTRACT

This disclosure pertains to a system in which web applications comprising of web presentation pages, which interact with users, have features that can be activated embedded in them. When these applications are installed on a host system, the features become activated and allow the host operators to customize or set up the applications to suit their presentation strategy. Further, the web applications may contain standard or typical features, common to most host systems. On such systems, the web applications will self configure or customize themselves to the host system on activation of those features that already have values on the host. Feature information will include a default value and a presentation element or content type. The combined information contained in the set will be used by the host to query operators for feature values additionally relieving applications the task of building feature setting procedures.

### REFERENCES CITED

U.S. patent Documents

| | | | |
|---|---|---|---|
| 6,275,225 | August 2001 | Rangarajan et. al | 345/333 |
| 6,192,382 | February 2001 | Lafer et. al | 707/513 |
| 6,163,878 | December 2000 | Jereme Kohl | 717/1 |
| 6,026,433 | February 2000 | D'Arlach et. al | 709/217 |

### OTHER PUBLICATION

Philip Greenspun, Internet Application Workbook, http://philip.greenspun.com/internet-application-workbook/, April 2001.

### CROSS-REFERENCE TO RELATED APPLICATIONS

Not Applicable

### STATEMENT REGARDING FEDERALLY SPNONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention relates to the presentation of web site pages and applications and particularly to how to make these pages customizable at run-time without additional user programming effort.

The early days of the Internet saw the worldwide web being used for presentation of information. The requirement for a good website was aesthetics and easy location of said information. Later, the advantages of using the Internet as a collaborative environment became recognized. Collaborative, business, and community management applications have since been developed. Some of these applications became offered as web services to which websites or organizations could subscribe. Some popular applications that have been operated in intranets and Internet sites range from collaborative applications such as conferencing and chat applications, to business applications such as customer management systems to online stores and even auction and gaming applications.

At the start, website owners had to write their own applications. Today, applications can be purchased that perform a specific task or web operators may write applications to take advantage of a web service provided by another site. Currently applications are very proprietary, and each sometimes duplicates a function by writing all application functions required for their specific task. Web services on the other hand reduce the cost of ownership by obviating the need to rewrite every function from scratch.

However, the demands for aesthetics that arise from the advent of the worldwide web still dictates that website owners would not want their sites to look exactly like the next website simply because they purchased applications from the same source. More importantly, the requirements of each site are so varied that one generic application might not be totally convenient. This is in contrast with the system for computer desktops in which almost every spreadsheet application on every different computer appears almost the same.

Web pages are made up of tags and/or style sheets. When completed, these web pages may be described as static if all the tag values have been completed by the page creator. Creating an installable application that would take a customized and different look on each site would require making some of those tags place-holders whose values are obtained at run-time from say, a repository or database system. However, as the number of pages and applications increase, or as applications become more customized, the requirement of running to the database to fetch numerous custom page features will exert a penalty on the speed of loading the pages.

An option is to place all possible custom features in memory making it easy to render them instantly on request. This way, the speed of page loading is hardly compromised but the memory requirements will be enormous. Caching procedures have been developed and applied to related problems that would alleviate this situation. However, the method by which features will be selected for caching, a universal scheme that determines if features are even relevant to a site or to a particular user, a scheme for feature interaction that determines how feature values may be set are aspects of the current invention that have not been previously addressed as a unit.

Another problem faced in the deployment of web applications is related to how the feature values will be set on installation at the target host. Many applications currently include physical style files or style sheets that can be modified to influence features of the application. For security reasons, it would not be desirable to have too many users on the network have access to the host system for purposes of modifying the physical style files. However, this restriction means that individual users or group of users will not be able to take charge of the features of their own pertinent applications without recourse to the technical administrator. One option to address this situation is to make features dynamically modifiable from the presentation pages themselves rather than from a physical style file. Then the application could include functions and presentation pages for setting the features with the applications. However, this will result in several applications each with a different feature setting system. This also adds to the size and cost of the application. A related problem is the case in which different applications may have similar features. For instance, a user management application may have a feature determining the kind of file a user may upload, while a relationship management application from a different provider also has a similar one. Strategically, it may be desirable to associate both features; being related to one single host security policy. This is currently quite difficult to accomplish using current schemes in which applications handle feature setting in a decentralized and separate method.

### BRIEF SUMMARY OF THE INVENTION

An object of the current invention is to provide a scheme that allows web applications obtained from diverse sources to be centrally customizable. Accordingly, the invention defines a unit of customizable feature or aspect of a web application page presentation, termed a feature. The value of a feature could provide a customizable aspect of an application. In the current invention, the feature is designed to be a composite unit containing embedded information including a name, default value, scope, persistence, query type, and query caption. This list is not intended to be limiting and the feature may also contain additional information embedded within its definition. In a preferred embodiment, the feature may be specified in the form of an XML node entrenched within an HTML document such that an HTML browser will render the feature using its default value on a system that has not implemented the method disclosed here. In another implementation, the feature may be provided as an object or component using a scripting language with ability to utilize object or component technology on a web server or other host system. Each information or part of the feature will then be a property of each feature object. Another possible implementation would be in any markup language or other presentation method used for wireless and hand-held devices. In this connection, a presentation item such as an HTML file, containing features as defined here will subsequently be referred to as feature-enabled.

The information embedded in the feature provides the following benefits compared with a plain tag embedded system. Firstly, the contained default value may be used to define the value of the feature when first encountered on the host system. This default value will remain the feature's value until the operators of the host system provide a custom value for it. Secondly, the information regarding the scope may be used to determine how many pages, files, or presentation items the feature will dominate. In the preferred embodiment, the scope value of a feature may be page-wide, application-wide, or site-wide. This aspect of the feature definition has a resource management imperative. The more features that are of application or site-wide scope, the less the storage and memory requirement compared to using features of page scope. Thirdly, information provided regarding the persistence of a feature determines how the feature value will be handled and stored. For instance, features that are designed to persist only for the user can be implemented as cookies and stored on the user's computer. Finally, the information regarding the query type and caption accompanying the feature is intended for use in building GUI query procedures by the host system in soliciting custom values for the feature. Possible query types include HTML GUI elements such as input, drop-downs, and option buttons. However, the current invention is intended to be general enough to consider implementation of feature querying methods in any client system with GUI form features.

On installation of a feature-enabled web application on a host system on which the method disclosed here has been implemented, the host system will register the feature the first time they are encountered. The host system encounters a feature in the process of reading, presenting, or compiling a presentation item or file in which the feature is embedded. Registration of the feature involves storing the details of the feature in some feature repository or database system.

Another aspect of the current invention is the incorporation of cache procedures such that the most frequently accessed, and most recently accessed feature are more readily available in the cache system.

An aspect of the disclosed method is provision for adoption of features of site scope that have been previously registered and provided with custom values prior to the addition of a new application. The previously set values of the site features may then be used as the feature value rather than its default value resulting in an application that auto customizes or self conforms to aspects of an existing host system. As a result, the current disclosure is intended to lead to a definition of any number of standards or schema for generally accepted or frequently defined features.

The advantages of the present invention are readily apparent from the following detailed description of the methods and a best mode considered for carrying out the invention.

### BRIEF DESCRIPTION OF THE DRAWINGS

FIG. 1 is a diagram includes elements of a system operating the current invention.

FIG. 2 is a diagram depicting a feature object including some of its important components.

FIG. 3 is a flow diagram representing how the system responds to a page containing features.

FIG. 4 is a diagram representing how the system sets or customizes features

FIG. 5 is a diagram illustrating some key elements of the feature memory management system.

### DETAILED DESCRIPTION OF THE INVENTION

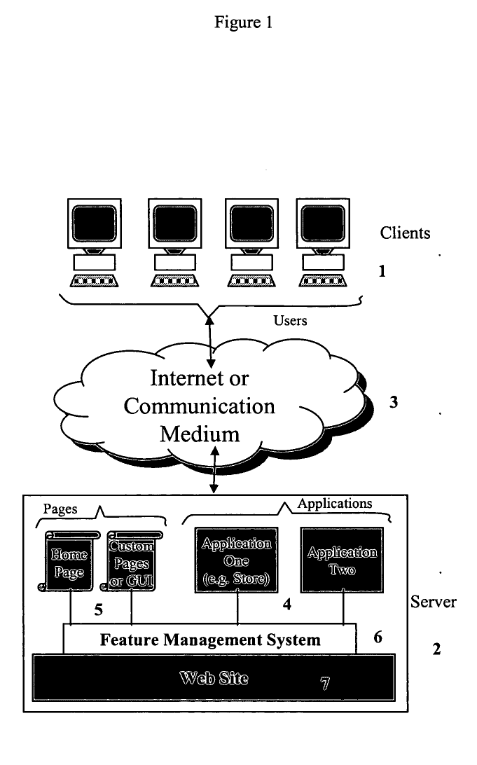

In the preferred embodiment, the current invention may be implemented on a client server system. The connection between the client and the server may be any network device, wireless -system, the Internet or the Intranet. Referring to FIG. 1, users 1 interacting with client systems may interact with the server system operating the current invention 2 via a network such as the Internet or other network communication medium 3. Resident on the host system would be applications 4 which are also developed to utilize the current invention, web pages 5 that have been imparted with provisions of the current invention, the feature management system 6 and a web server 7 or server management system. The feature management system will contain functions and programs implemented according to the descriptions subsequently disclosed here.

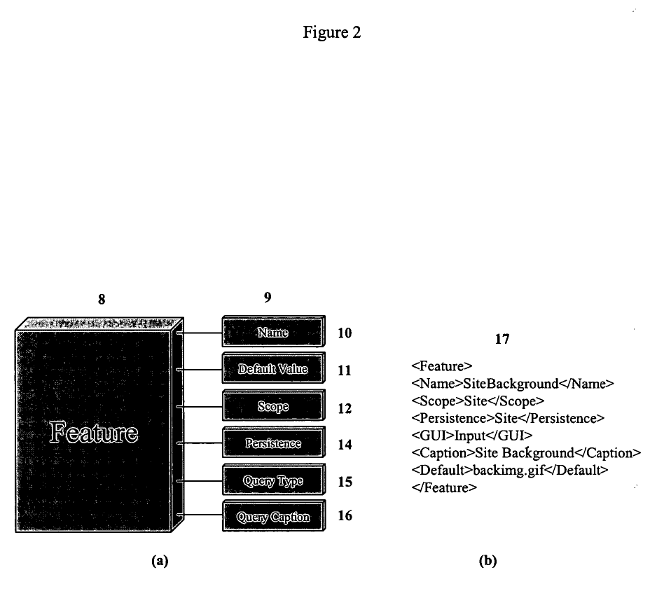

In the current invention, a feature object 8; depicted in FIG. 2 and subsequently referred to simply as a feature; will be a unit containing a plurality of discrete information 9. The information embedded in the feature will include a name 10, default value 11, scope 12, persistence specification 13, GUI query type 14, query caption 15, and any other information 16 that the application programmer intends to convey to the host system regarding the feature. In the preferred embodiment, the feature unit may be implemented as an XML node 17 embedded in an HTML document such that a host system which has not been imparted with the provisions of the current invention will simply render the feature using its default value. In a different implementation, the feature may be implemented as an object in an application scripting language or as an instance of a component using object component methods. An application containing embedded features in its implementation files will subsequently be referred to as a feature-enabled application.

The information embedded within the feature will be accessed by the host system, which will in turn act on the mentioned information as described below.

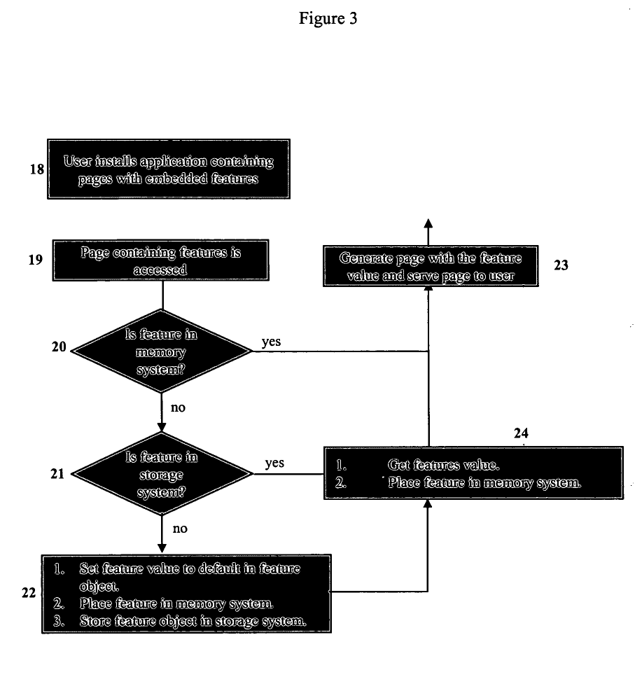

The following description refers to FIG. 3. On installation of a feature-enabled application 18, the features embedded in the application's presentation files are initially dormant. However, the first time the features are encountered by the host system 19, the features are activated. The host system will encounter the features in the process of interpreting or processing the presentation files. The process of activation of the feature is two-folds:

Firstly, the host system checks the memory 20, or specifically the feature cache, to determine if a value is available for the feature. If no value is available for the feature, the host system uses the feature's default value to represent the feature. This value is also placed in the feature cache in accordance with the cache management procedures disclosed in a later part of this section. However, the host system may actually have set values for the feature if it is a site feature that has previously been declared by a different application of some other file on the host system. If a set or custom value exists for the feature, the system uses the set value to represent the feature 21. This aspect of the current invention results in a system in which installed applications may self-customize to fit aspects of a host system on which they are installed.

Secondly, the host system checks the feature repository 22, which may be a database or other storage implementation method, to determine if the feature is registered. If the feature is not found in the repository or feature registry, the feature and its embedded information are stored 23. The value which will be used for the future rendering of the feature will be its default value stored with the feature in the repository. However, the value of the feature may be separately changed or customized by operators of the host system. If the feature is found in the repository, the value of the feature in the repository is used to render the feature 24. The feature may only be found in the repository if it is a site feature that has been previously declared by a different application or file on the host system. The process of customizing the feature or providing custom values for it is described next.

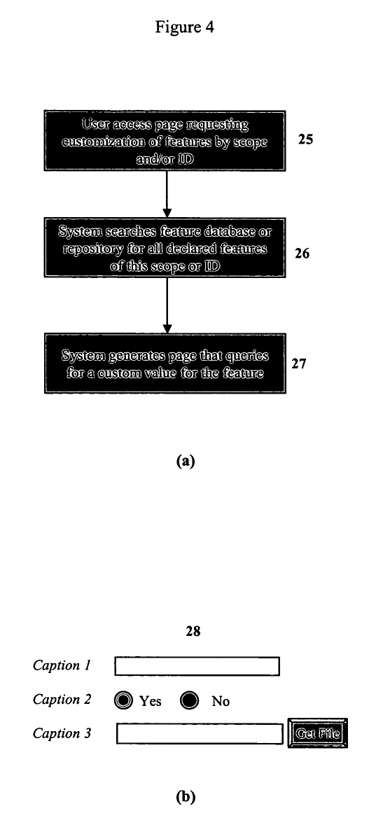

Referring to FIG. 4, the first part of the figure illustrates a situation in which an operator or a designated user with appropriate access seeks to customize a feature residing in the repository 25. Implementation of the current invention will provide an interface for providing custom values for the feature. In the preferred embodiment, the feature customization page will be a web page with programs and functions to generate a form for soliciting custom values based on the features to be modified. The system searches the database for all features fitting criteria for features the user wishes to modify 26. The system then generates a form for providing custom values for the feature using the information on GUI query type and query caption stored with each feature 27. For instance, in FIG. 4b, a feature customization form consisting of three features to be customized is shown 28. In the figure, the query caption values of the features have been assumed to be “Caption 1”, “Caption 2”, and “Caption 3”, for simplicity. The query types for each feature will have been determined by the web application or page author to be input, selection button, and input, respectively. However, generic names for input types have been defined such that a feature customization form can be presented in any GUI presentation environment including web devices, hand held devices, or any client device with appropriate form presentation methods.

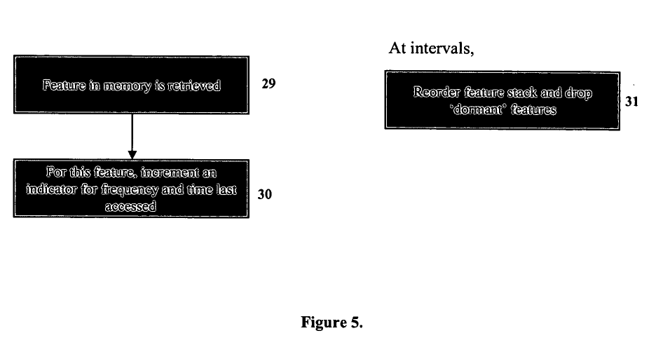

Finally, implementation of the feature cache is intended to follow previously procedures for managing memory cache and implement able by one skilled in the background art. In addition, to conventional caching methods, the current invention suggests modifications such that features may be dropped from the cache when they have not been accessed in a long time, If they are not accessed frequently. Referring to FIG. 5, the memory cache is considered as a stack of feature values stored in memory for quick retrieval in rendering feature-enabled pages. The object of the cache is to achieve quick retrieval of frequently accessed features as well as recently accessed features. In accordance, features that have not been accessed will not be in the cache. In fact, a feature that has never been accessed will not even be registered on the system even though it resides in some file on it.

Every time a feature in memory is accessed or placed in memory the first time 29, the number of times this feature is accessed and how recently are noted 30. The reorder step 31 contains a rating system that considers the relevance of features by a combination of frequency and freshness. The rating is a logarithmic equation of the form:
R=A LOG(xᵢ)+Bi^{y}+History Term

R is the rating for the feature, i is the total number of times the feature was called, and xᵢ are the various times the feature was called each i times. The first term on the right is tweaked to weigh more recent calls higher than older ones. The second term on the right is tweaked to put premium on the number of calls (tweaking means obtaining values for A, B and y). It is also possible to use an algebraic equation for faster computation for systems with higher feature buffer sizes.

Based on the above disclosure, this method of feature management is one of feature availability based on a most recently accessed; most frequently accessed criteria, while feature registration is on an as-needed basis.

In conclusion, even though the features as described above are set using designs embodied in the feature object definition, the customized values of the feature may be set in alternative ways without compromising the intention of the current invention. For instance, the application developer could also write program that directly accesses the repository and sets the feature's value.

Thus, while the best mode for carrying out the invention has been described in detail, those familiar with the art to which this invention relates will recognize various alternative designs and embodiments for practicing the invention as defined by the following claims.

What is claimed is:

1. A computer controlled method for allowing a user of a computer application presented over a network, that users a graphical user interface (GUI), to customize said user's interaction with said application through said GUI, said method comprising the steps of:
Accessing the application's customizable features in the process of interpreting or presenting the said application's presentation pages;
Storing the application's features in a storage device;
Placing the application's features in memory or a feature cache;
using the features available in the said storage and cache for generating the application's presentation pages customizing the application's appearance and/or its response to the user:

2. The method in claim 1 further comprising the steps of:
Generating one or more interrogatories, relating to said application's stored features;
Presenting the one or more interrogatories to said user;
Obtaining from said user at least one response to said one or more interrogatories relating to said application's features;
Using the response from said user to replace a default value provided and stored with the said application's features;
Using the response from said user to replace the value of said feature in storage and in cache.

3. The method of claim 1 further comprising the step in which:
The application developer embeds features within the application's presentation files;
The said features are embedded as composite information comprising a plurality of parts;
The said parts including an identification information, a default value, and interrogatory generation information.

4. The method of claim 1 further comprising the step of using a custom value for the feature from a value previously set for another similar feature.

5. The method of claim 1 further comprising the steps of:
Determining whether a feature is already in memory or cache, and if so, using its value for generating or processing the application's presentation pages;
Determining whether a feature not in memory is stored, and if so, retrieving its value from its stored value for placement in the memory or cache;
Storing a feature in said storage when its value is neither in memory or storage.

6. A system for constructing and customizing an application's graphical user interface (GUI) presentation pages in response to a user accessing said application via a network, comprising:
A server processor that receives and processes the user's response and interaction with said application;
A storage device connected to said server processor for storing a plurality of said application's customizable features;
A feature cache for storing said application's customizable features;
A mapping logic processor in communication with said server processor, said storage device, and said feature cache, and arranged to generate application's presentation pages and response to said user based on customized values of the said application's features.

7. The system of claim 6 wherein said mapping logic unit is arranged to:
Generate at least one or more interrogatories in relation to the said stored application's features;
Present the said one or more interrogatories to said user;
Obtaining from said user one or more responses to said one or more interrogatories;
Using the value of said user response to replace the value of said application's features in said storage and feature cache;

8. The system of claim 6 wherein said mapping logic unit is arranged to use previously set custom values of other similar features for said application's features.

9. The system of claim 6 wherein said mapping logic unit is arranged to:
Determine whether a feature is already in memory or cache, and if so, use its value to generate or process the application's presentation pages;
Determine whether a feature not in memory is stored, and if so, retrieve its value from its stored value for placement in the memory or cache;
Store a feature in said storage when its value is neither in memory or storage.

10. A system for conveying an application's customizable features to system in claim 6 comprising:
Application programs and files with customizable features embedded in them;
Wherein said customizable features are embedded as composite information comprising a plurality of parts;
Wherein said parts contain at least a default value, an identification, and interrogatory generation information.
